(19) United States
(12) Patent Application Publication
(10) Pub. No.: US 2012/0107473 A1
(43) Pub. Date: May 3, 2012

(54) Reduction of fuel requirements in carbon dioxide production for beverage filling operation

(75) Inventor: Garry Paul Lowe, Ormand Beach, FL (US)

(73) Assignee: The Wittemann Company LLC

(21) Appl. No.: 12/925,834

(22) Filed: Nov. 1, 2010

(51) Int. Cl. A23L 2/54

(52) U.S. Cl. 426/477; 261/143

(57) ABSTRACT

The method of supplying purified CO₂ to beverage filling process, which includes compressing ambient air, feeding the compressed air and hydrocarbon fuel to a burner, for combustion to form CO₂ and water, supplying flue gas containing CO₂, N₂, O₂ and water to an extraction process wherein CO₂ is extracted as a high purity gaseous stream, compressing, drying and liquefying the CO₂ in the stream, for storage, and, in response to beverage filling needs for CO₂, vaporizing liquid CO₂ and delivering gaseous CO₂ to a beverage filling operation, and, in this process or similar processes, re-using CO₂ obtained from the beverage filling operation. Typically, such obtained CO₂ is returned to the burner, via a blower, or may alternatively be supplied to burner output flue gas.

### BACKGROUND OF THE INVENTION

This invention relates generally to method and apparatus for handling carbon dioxide produced by fuel combustion, and subsequent purification and use, so as to enhance process efficiency, and particularly in regards to filling carbonated beverage containers.

Carbon dioxide use in such systems may typically be produced by fuel combustion. The economic viability of such process to produce carbon dioxide is fuel cost. Typically fuel and air are mixed and burned to produce a flue gas containing CO₂ with the remaining major components being water, nitrogen, and oxygen. The flue gas is processed through an amine system which extracts the CO₂ from the flue gas yielding a 99+vol % CO₂ stream (on a dry basis) while venting the majority of the O2 and N2. The CO₂ then is sent for further processing, liquefaction and storage for further use as a beverage grade product.

There is need to improve the process to effectively reduce the specific fuel consumption necessary to produce a beverage grade CO₂ product by processing CO₂ off-gas from beverage filling lines than that possible with conventional CO₂ production systems alone.

### SUMMARY OF THE INVENTION

In beverage filling operations, utilizing a carbon dioxide production system, a carbonated beverage filling line is typically located at the same facility.

A carbonated beverage filling line or operation fills various types of containers such as cans and bottles with a product. Liquid CO₂ from a storage tank is vaporized and then used in the beverage filling line to carbonate the beverage, and purge and/or blanket the container. The off-gas of this process consists of concentration of CO₂ generally greater than 70 volume % with the majority of the balance consisting of nitrogen and oxygen. Other trace impurities (ppmv levels) are also present.

One major object of the invention is to use the carbonated beverage filling lines off-gas by returning this gas, under pressure or vacuum, to the CO₂ production system for purification and processing, to combine with carbon dioxide produced by fuel combustion. The combustible impurities present in the off-gas are eliminated by thermal oxidation at the burner during the combustion process. This approach eliminates the need for additional purification steps that may otherwise be required to eliminate trace combustible impurities.

Another object is to reject N2 and O2 components of the off-gas stream separated in the amine system while the CO₂ in the off-gas stream is collected. The recovery of this CO₂ lowers the overall specific fuel consumption. The invention avoids need to recover CO₂ from beverage filling line off-gas by investing in an additional plant which will generally result in lower CO₂ collection efficiencies and higher capital and operating costs.

These and other objects and advantages of the invention, as well as the details of an illustrative embodiment, will be more fully understood from the following specification and drawings, in which:

### DRAWING DESCRIPTION

FIG. 1 is a system block diagram illustrating the overall process of the invention;

FIG. 2 is a more detailed view of elements of the overall process;

FIG. 3 shows a modification;

FIGS. 4 and 5 show further modifications.

### DETAILED DESCRIPTION

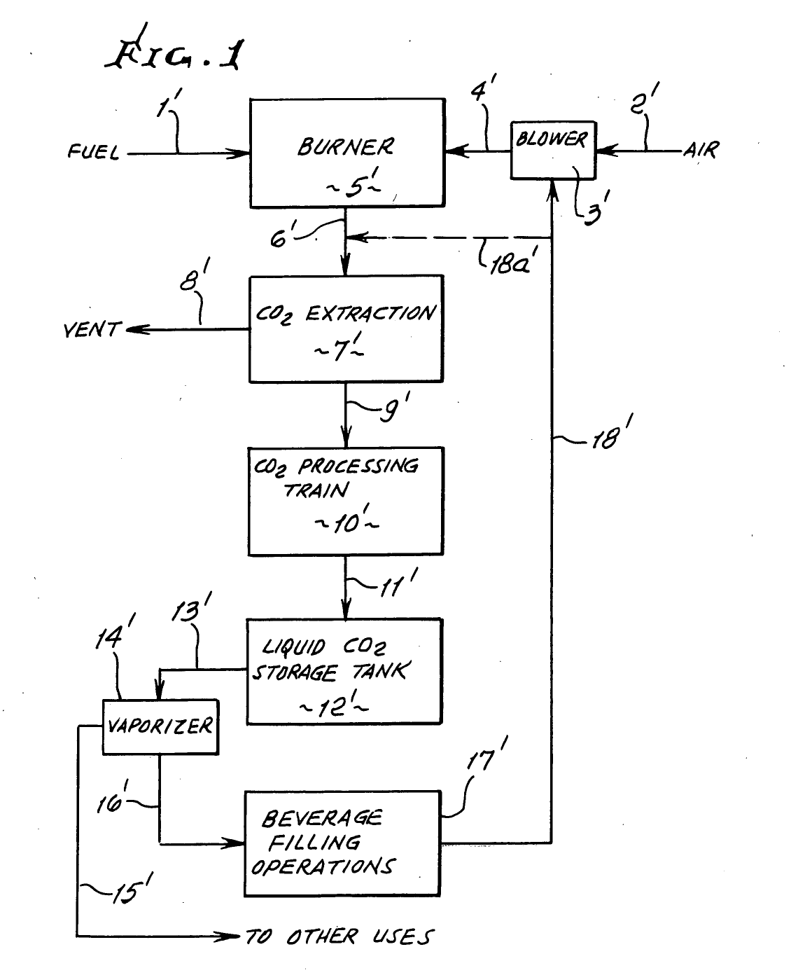

Referring to FIG. 1, ambient air stream 2′, is drawn from the atmosphere and compressed in blower 3′. Compressed air stream 4′ and oil or natural gas stream 1′ are fed to burner 5′. The fuel and air are ignited and combusted the fuel being oxidized to carbon dioxide and water. A flue gas, stream 6′ is the final product of combustion, mainly containing carbon dioxide, water, nitrogen and oxygen. The amine system 7′ extracts the CO₂ from the flue gas and vents mostly nitrogen, oxygen, and water stream 8′, to atmosphere. A relatively high purity gaseous CO₂, stream 9′, is purified, compressed, dried and liquefied in processing train 10′ and a beverage grade CO₂ product 11′ is delivered to liquid CO₂ storage tank 12′. As plant demand dictates, liquid CO₂ stream 13′, is delivered to vaporizer 14 where heat converts the liquid to a gas.

The gaseous CO₂ can be used for other needs, and stream 15′, specifically refers to such uses. Vapor CO₂ from the vaporizer, stream 16′, is delivered to beverage filling line operations 17′. The off-gas from the bottling process, stream 18′, is returned to the CO₂ production system at blower 3, where it mixes with the ambient air 2′. Pressure of CO₂ at the beverage filling operation is used to drive CO₂ at 18′ or alternately blower suction at vacuum pulls it in. The compressed air and off-gas “mix”, stream 4′, and a reduced quantity of oil or natural gas, stream 1′, are ignited in burner 5′ and combusted for producing flue gas, stream 6′, containing a similar quantity of CO₂ than during standard operating conditions. Some or all of the off-gas from the beverage filling process, stream 18′, can be returned at 18a′ to the CO₂ production system at stream 6′, shown with a dashed line, where it is mixed with flue gas.

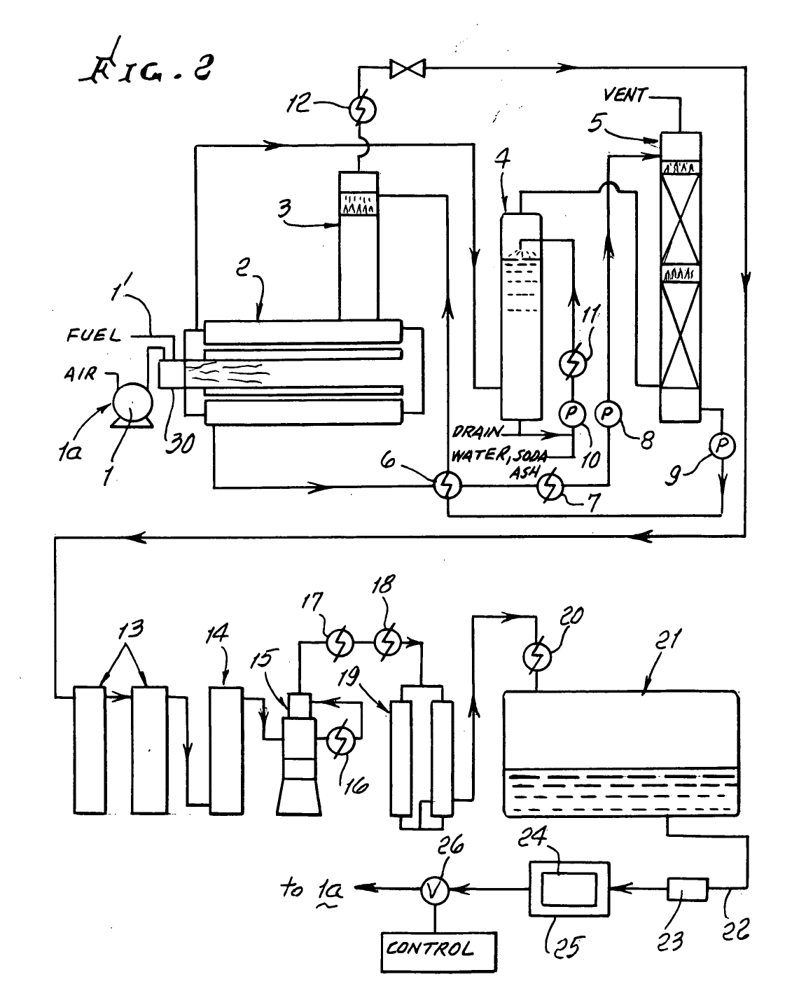

Referring now to FIG. 2, it shows in more detail components of one representation CO₂ production system, to which the present invention is applicable. The invention is applicable to other CO₂ production systems. Components in FIG. 2 include:
1. Air Blower
2. CO₂ Regenerator
3. Stripper Tower
4. Direct Contact Cooler/Scrubber
5. Absorber Tower
6. Lean/Rich Exchanger
7. Trim Cooler
8. Lean Pump
9. Rich Pump
10. Recirculation Pump
11. Recirculation Cooler
12. Product Cooler
13. KmnO4 Bubblers
14. WittFill Tower
15. CO₂ Compressor
16. Intercooler
17. Aftercooler
18. High Pressure Precooler
19. Dual Tower CO₂ Dryer
20. CO₂ Condenser
21. Liquid CO₂ Storage Tank

Line 22 from tank 21 delivers liquid CO₂ to vaporizer 23, from which pressurized CO₂ vapor or gas is delivered to beverage filling process 24 within housing 25. The off-gas CO₂ within 24 is delivered, as via control valve 26, to the intake side 1a of the air blower 1. Air intake to that blower mixes with the off-gas stream, and the mix at is delivered by the blower to burner 30 for combustion with fuel delivered from 1′ for combustion.

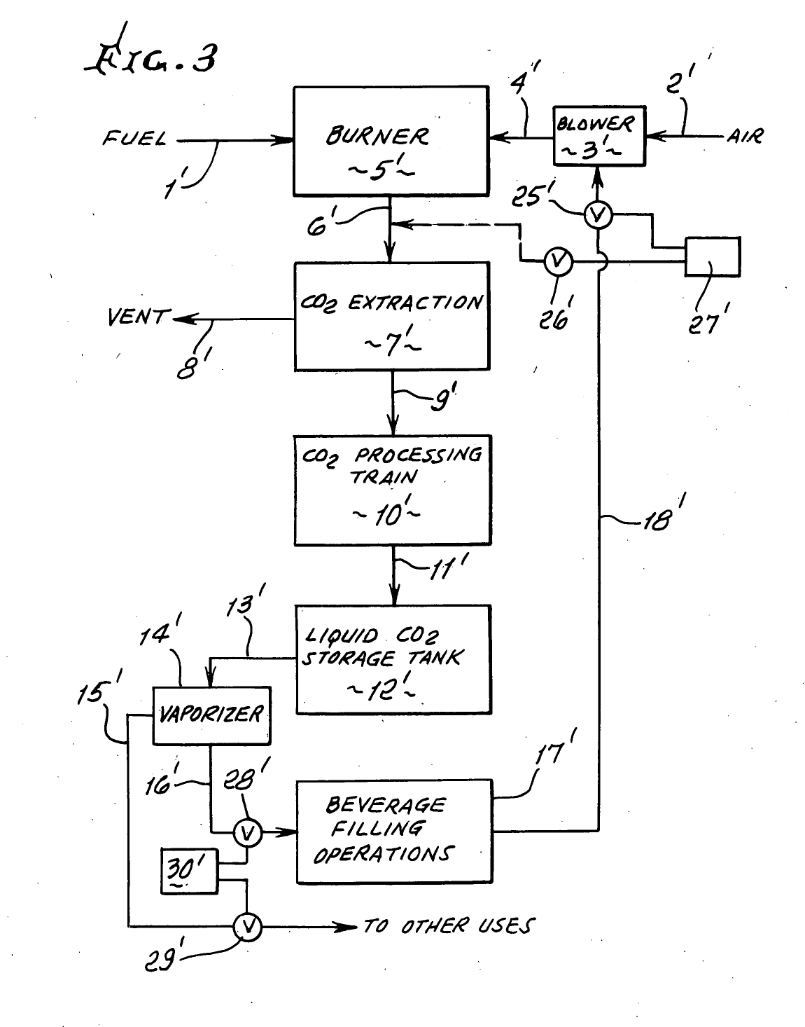

In FIG. 3, valves are shown at 25′ and 26′, and may be controlled as at 27′. Valve 25′ controls the flow of CO₂, delivered from 18, to the blower 3′; or valve 26′ may control the flow of CO₂ to 6′, i.e. to mix with flue gas. Control 27′ may be used to adjust 25′ and 26′ to achieve most efficient production of CO₂ delivered to 7′.

Control valve 28′ may be used to control flow of CO₂ via 16′ to the operations at 17′; and control valve 29′ may be used to control flow of CO₂ via 15′ to other uses, as indicated. Controller 30′ may be used to adjust valves 28′ and 29′ to enhance efficiency of CO₂ uses.

In the above, the valves 25′, 26′, 28′ and 29′ may be manually or control set at established flow rates, or the flow rates may be pre-established, so that valves are not needed.

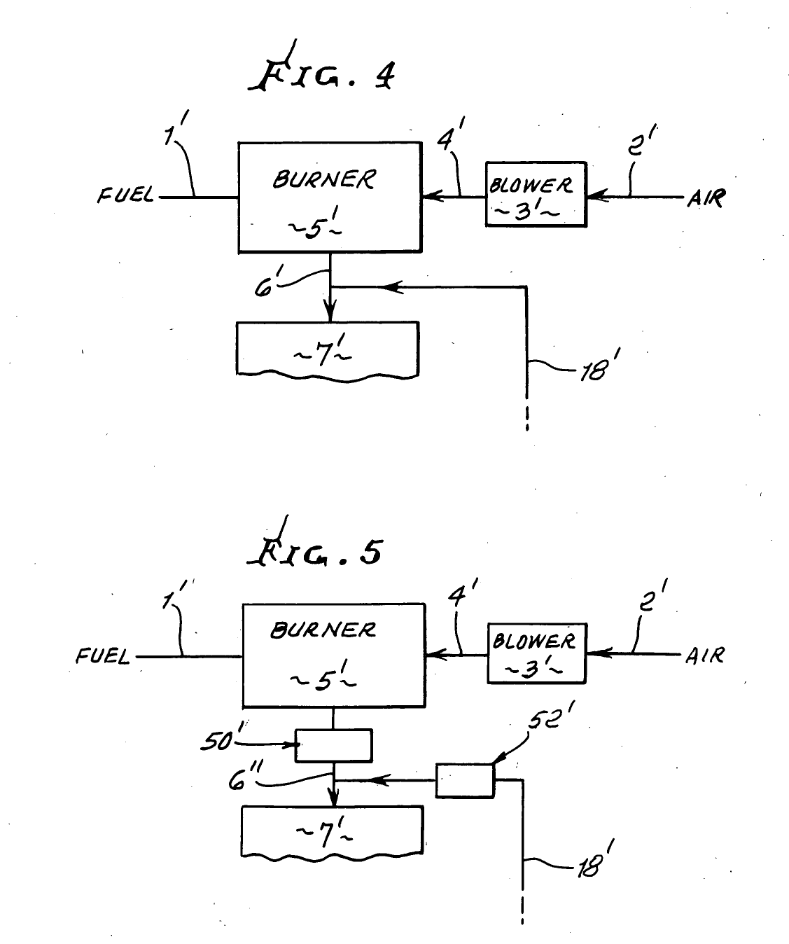

FIG. 4 is like FIG. 1 except that the off-gas stream 18′ is returned to mix with flue gas stream 6′.

FIG. 5 is also like FIG. 1, except that a blower 50′ is added in a flow gas path 6″, at the output side of blower 50′. An additional blower 52′ is employed in path 18′ to boost pressure of returned off-gas for delivery to 6″.

What is claimed is:

1. The method of supplying purified CO₂ to a beverage filling process, that includes
a) compressing ambient air,
b) feeding the compressed air and hydrocarbon fuel to a burner, for combustion to form CO₂ and water,
c) supplying burner flue gas containing CO₂, N₂, O₂ and water to an extraction process wherein CO₂ is extracted as a high purity gaseous stream,
d) compressing, drying and liquefying the CO₂ in said stream, for storage,
e) and, in response to beverage filling needs for CO₂, vaporizing liquid CO₂ and delivering gaseous CO₂ to a beverage filling operation,
f) and re-using CO₂ from the beverage filling operation in the process.

2. The method of claim 1 including returning off-gas, from the beverage filling operation to one of the following:
i) to the a) step ambient air being compressed for mixture therewith,
ii) to burner flue gas being supplied to the extraction process.

3. The method of claim 2 including operating a blower for compressing said ambient air and returned off-gas.

4. The method of claim 1 wherein said c) step includes venting to atmosphere the N₂, O₂ and water, from which CO₂ has been extracted.

5. The method of claim 1 wherein said c) step includes employing amine in said CO₂ extraction.

6. The method of claim 1 including delivering said off-gas to mix with ambient air being compressed.

7. The method of claim 1 including delivering said off-gas to said extraction process.

8. Apparatus for supplying purified CO₂ to a beverage filling process, comprising
a) first means operating to compress ambient air,
b) second means for feeding the compressed air and hydrocarbon fuel to a burner, for combustion to form CO₂ and water,
c) third means for supplying flue gas containing CO₂, N₂, O₂ and water to an extraction process wherein CO₂ is extracted as a high purity gaseous stream,
d) fourth means for compressing, drying and liquefying the CO₂ in said stream, for storage,
e) and, in response to beverage filling needs for CO₂, vaporizing liquid CO₂ and delivering gaseous CO₂ to a beverage filling operation, producing off-gas,
f) and means for delivering said off-gas for re-use by said apparatus.

9. The apparatus of claim 8 including means for directing said off-gas delivery to said first means.

10. The apparatus of claim 8 including means for directing said off-gas delivery to said fourth means.

11. The method of claim 1 wherein said step
f) includes controlling the flow of CO₂ from the beverage filling operation, to control said re-using.

12. The method of claim 11 wherein said controlling includes controlling the flow of CO₂ being re-used to mix with said ambient air being compressed.

13. The method of claim 12 wherein said controlling also includes controlling the flow of CO₂ being re-used to mix with said flue gas.

14. The method of claim 1 including controlling the flow of CO₂ being delivered to said beverage filling operation, and controlling the flow of CO₂ to other uses.

15. In the method of supplying purified CO₂ to a beverage filling process, that includes:
a) compressing ambient air,
b) feeding the compressed air and hydrocarbon fuel to a burner, for combustion to form CO₂ and water,
c) supplying burner flue gas containing CO₂, N₂, O₂ and water to an extraction process wherein CO₂ is extracted as a high purity gaseous stream,
d) compressing, drying and liquefying the CO₂ in said stream, for storage,
e) and, in response to beverage filling needs for CO₂, vaporizing liquid CO₂ and delivering gaseous CO₂ to a beverage filling operation, the improvement step comprising
f) re-using CO₂ from the beverage filling operation in the process.

16. The improvement of claim 15 that includes returning off-gas from the beverage filling operation to at least one of the following:
i) to ambient air being compressed, for mixture therewith,
ii) to burner flue gas being supplied to the extraction process.

17. The method of claim 1 including providing and operating a flue gas blower to compress said flue gas supplied to the extraction process, and wherein the CO₂ from the beverage filling operation is supplied to mix with flue gas at the output side of the blower.

18. The method of claim 17 including providing and operating an additional blower to receive and compress said CO₂ from the beverage filling operation, for delivery to mix with the flue gas at the output side of the flue gas blower.
